(19) United States
(12) Patent Application Publication
(10) Pub. No.: US 2018/0118772 A1
(43) Pub. Date: May 3, 2018

(54) CATALYST FOR SYNTHESIZING METHANOL OR ITS PRECURSOR, METHOD FOR PREPARING THE CATALYST AND METHOD FOR PRODUCING METHANOL OR ITS PRECURSOR USING THE CATALYST

(71) Applicant: KOREA INSTITUTE OF SCIENCE AND TECHNOLOGY, Seoul (KR)

(72) Inventors: Hyun Joo LEE, Seoul (KR); Hyunah CHOO, Seoul (KR); Hyejeong LEE, Seoul (KR); Seungmi YEO, Seoul (KR); Moo Seong PARK, Seoul (KR); Soon Hyeok HONG, Seoul (US); Jaewoon KIM, Seoul (US)

(21) Appl. No.: 15/399,174

(22) Filed: Jan. 5, 2017

(30) Foreign Application Priority Data
Oct. 31, 2016 (KR) 10-2016-0142912

(51) Int. Cl. C07F 15/00; B01J 31/18

(52) U.S. Cl. CPC C07F 15/0093; B01J 31/1815; B01J 2531/828; B01J 2231/40; B01J 31/1805

(57) ABSTRACT

Disclosed is a novel catalyst having amine ligands for synthesizing methanol or its precursor. When the catalyst is allowed to react with an alkane in the presence of an acid, at least one C—H bond of the alkane is catalytically oxidized. Therefore, the catalyst is suitable for use in forming an alkyl ester from an alkane.

### CROSS-REFERENCE TO RELATED APPLICATIONS

This application claims, under 35 U.S.C. § 119, the priority of Korean Patent Application No. 10-2016-0142912 filed on Oct. 31, 2016 in the Korean Intellectual Property Office, the disclosure of which is incorporated herein by reference in its entirety.

### BACKGROUND OF THE INVENTION

### 1. Field of the Invention

The present invention relates to a catalyst for synthesizing methanol or its precursor, a method for preparing the catalyst, and a method for producing methanol or methyl bisulfate as a methanol precursor using the catalyst. More specifically, the present invention relates to a diamine-coordinated Pt catalyst, a method for preparing the catalyst, and a method for producing methyl bisulfate or even methanol by reacting the catalyst with methane gas in the presence of fuming sulfuric acid.

### 2. Description of the Related Art

Methane is one of the most abundant resources on earth and has very high chemical stability. Due to its potential availability and economic efficiency, methane is recognized as an important alternative energy source to fossil fuels.

However, since methane is in a gaseous state at room temperature and has a low boiling point (−161.5° C.), it takes a large volume at room temperature and is limited in transport and transfer. Using liquid methanol converted from methane by partial oxidation can provide a solution to overcome the disadvantages of methane gas and allows the supply of a larger amount of methane gas, enabling the use of methane in various applications.

Generally, liquefaction techniques for the conversion of methane to methanol require high temperature and high pressure conditions but have difficulty in increasing the temperature and maintaining the pressure. Such liquefaction techniques suffer from high cost and low yield.

Specifically, methanol is synthesized from syngas which can be obtained from reforming of methane at a high temperature, typically at 800° C. Therefore, this reaction requires a high equipment cost for high temperature, and a large quantity of energy.

In an attempt to solve such problems, (bpym)PtCl₂, called the Periana catalyst, was developed. However, the turnover number (TON) and turnover frequency (TOF) of the Periana catalyst in the synthesis of methanol from methane are limited to 500 and 36/h, respectively.

Techniques for producing methanol by the reaction of methane with oxygen using a heterogeneous catalyst have also been developed. However, the reaction still requires a high temperature of 600° C. or above and the catalyst has a very low selectivity despite its high ability to convert methane to methanol.

### PRIOR ART DOCUMENTS

### Patent Documents

1. Korean Patent Publication No. 10-2009-0008102

### SUMMARY OF THE INVENTION

The present inventors have made efforts to solve the aforementioned problems and limitations of conventional catalysts and to develop a platinum catalyst with good stability and catalytic activity that can be used to synthesize a methanol precursor or methanol with high efficiency under low temperature and low pressure conditions. As a result of such efforts, the present inventors arrived at the present invention.

The present invention has been made in view of the above problems and is intended to provide a catalyst for synthesizing methanol or its precursor, a method for preparing the catalyst, and a method for producing methanol or methyl bisulfate as a methanol precursor using the catalyst.

One aspect of the present invention provides a catalyst for synthesizing methanol or its precursor, represented by one of Formulae 1, 2, and 3 described in the following section.

A further aspect of the present invention provides a method for preparing the catalyst.

Another aspect of the present invention provides a method for producing methanol or methyl bisulfate as a methanol precursor using the catalyst.

The novel catalyst of the present invention has amine ligands and can be used to synthesize methanol or its precursor. When the catalyst of the present invention is allowed to react with methane in the presence of an acid, at least one C—H bond of the methane is catalytically oxidized to form a methyl ester in high yield. That is, the catalyst of the present invention can be used for methane oxidation. The methyl ester reacts with water to synthesize methanol. Therefore, the Pt complexes can also be used to synthesize methanol through methane oxidation.

In addition, the catalyst of the present invention can drive the reaction to lower temperature and lower pressure conditions and is effective in producing methanol or its precursor in high yield due to its good catalytic activity. Furthermore, the catalyst of the present invention is advantageous in terms of economic efficiency because it is simple and easy to prepare. The catalyst of the present invention is highly stable so as not to be easily lost and decomposed during the reaction, ensuring its long-term use.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a ¹H-NMR spectrum of methyl bisulfate (CH₃OSO₃H) synthesized using the catalyst of Formula 3-2 in Example 2;

FIG. 2 shows the results of HPLC analysis for methanol synthesized using the catalyst of Formula 3-2 in Example 2; and

FIGS. 3 to 15 are ¹H-NMR spectra of catalysts prepared in Example 1.

### DETAILED DESCRIPTION OF THE INVENTION

Several aspects and various embodiments of the present invention will now be described in more detail.

One aspect of the present invention is directed to a catalyst for synthesizing methanol or its precursor, represented by one of Formulae 1, 2, and 3:

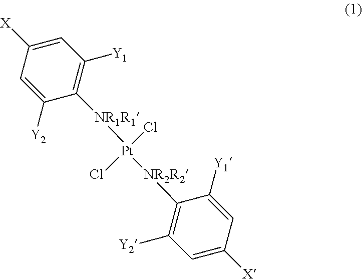

wherein R₁, R₁′, R₂, and R₂′ are the same as or different from each other and are each independently hydrogen or a C₁-C₃ alkyl group, X and X′ are the same as or different from each other and are each independently selected from hydrogen, C₁-C₃ alkyl groups, halogen groups, C₁-C₃ alkoxy groups, a nitro group, a carboxyl group, and a sulfonic acid group (—SO₃H), and Y₁, Y₁′, Y₂, and Y₂′ are the same as or different from each other and are each independently hydrogen or a C₁-C₃ alkyl group;

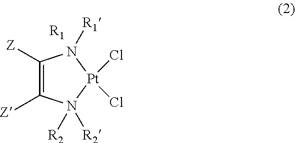

wherein R₁, R₁′, R₂, and R₂′ are as defined in Formula 1 and Z and Z′ are all hydrogen or together form a benzene or cyclohexyl ring with adjacent carbon atoms; and

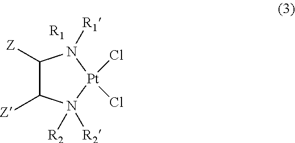

wherein R₁, R₁′, R₂, and R₂′ are as defined in Formula 1 and Z and Z′ are as defined in Formula 2.

According to one embodiment, the catalyst has the structure of Formula 1 wherein R₁, R₁′, R₂, and R₂′ are the same as or different from each other and are each independently hydrogen or a C₁-C₃ alkyl group, X and X′ are the same as or different from each other and are each independently selected from hydrogen, C₁-C₃ alkyl groups, halogen groups, C₁-C₃ alkoxy groups, a nitro group, a carboxyl group, and a sulfonic acid group (—SO₃H), and Y₁, Y₁′, Y₂, and Y₂′ are the same as or different from each other and are each independently hydrogen or a C₁-C₃ alkyl group.

In a preferred embodiment, in Formula 1, R₁, R₁′, R₂, and R₂′ are the same as or different from each other and are each independently hydrogen or a methyl group, X and X′ are the same as or different from each other and are each independently selected from hydrogen, a methyl group, halogen groups, a methoxy group, a nitro group, a carboxyl group, and a sulfonic acid group (—SO₃H), and Y₁, Y₁′, Y₂, and Y₂′ are the same as or different from each other and are each independently hydrogen or a methyl group.

In a more preferred embodiment, in Formula 1, R₁, R₁′, R₂, and R₂′ are all hydrogen, X and X′ are the same and are selected from hydrogen, C₁-C₃ alkyl groups, halogen groups, C₁-C₃ alkoxy groups, a nitro group, a carboxyl group, and a sulfonic acid group (—SO₃H), and Y₁, Y₁′, Y₂, and Y₂′ are the same and are hydrogen or a C₁-C₃ alkyl group.

In a most preferred embodiment, in Formula 1, R₁, R₁′, R₂, and R₂′ are all hydrogen, X and X′ are the same and are selected from hydrogen, a methyl group, halogen groups, a methoxy group, a nitro group, a carboxyl group, and a sulfonic acid group (—SO₃H), and Y₁, Y₁′, Y₂, and Y₂′ are the same and are hydrogen or a methyl group.

According to a further embodiment, the catalyst has the structure of Formula 2 wherein R₁, R₁′, R₂, and R₂′ are the same as or different from each other and are each independently hydrogen or a C₁-C₃ alkyl group and Z and Z′ are all hydrogen or together form a benzene ring with adjacent carbon atoms.

In a preferred embodiment, in Formula 2, R₁, R₁′, R₂, and R₂′ are the same as or different from each other and are each independently hydrogen or a methyl group and Z and Z′ are all hydrogen or together form a benzene ring with adjacent carbon atoms.

In a more preferred embodiment, in Formula 2, R₁, R₁′, R₂, and R₂′ are the same and are hydrogen or a C₁-C₃ alkyl group and Z and Z′ are all hydrogen or together form a benzene ring with adjacent carbon atoms.

In a most preferred embodiment, in Formula 2, R₁, R₁′, R₂, and R₂′ are the same and are hydrogen or a methyl and Z and Z′ are all hydrogen or together form a benzene ring with adjacent carbon atoms.

According to another embodiment, the catalyst has the structure of Formula 3 wherein R₁, R₁′, R₂, and R₂′ are the same as or different from each other and are each independently hydrogen or a C₁-C₃ alkyl group and Z and Z′ are all hydrogen or together form a cyclohexyl ring with adjacent carbon atoms.

In a preferred embodiment, in Formula 3, R₁, R₁′, R₂, and R₂′ are the same as or different from each other and are each independently hydrogen or a methyl group and Z and Z′ are all hydrogen or together form a cyclohexyl ring with adjacent carbon atoms.

In a more preferred embodiment, in Formula 3, R₁, R₁′, R₂, and R₂′ are the same and are hydrogen or a C₁-C₃ alkyl group and Z and Z′ are all hydrogen or together form a cyclohexyl ring with adjacent carbon atoms.

In a most preferred embodiment, in Formula 3, R₁, R₁′, R₂, and R₂′ are the same and are hydrogen or a methyl and Z and Z′ are all hydrogen or together form a cyclohexyl ring with adjacent carbon atoms.

According to another embodiment, the catalyst has one of the following structures:

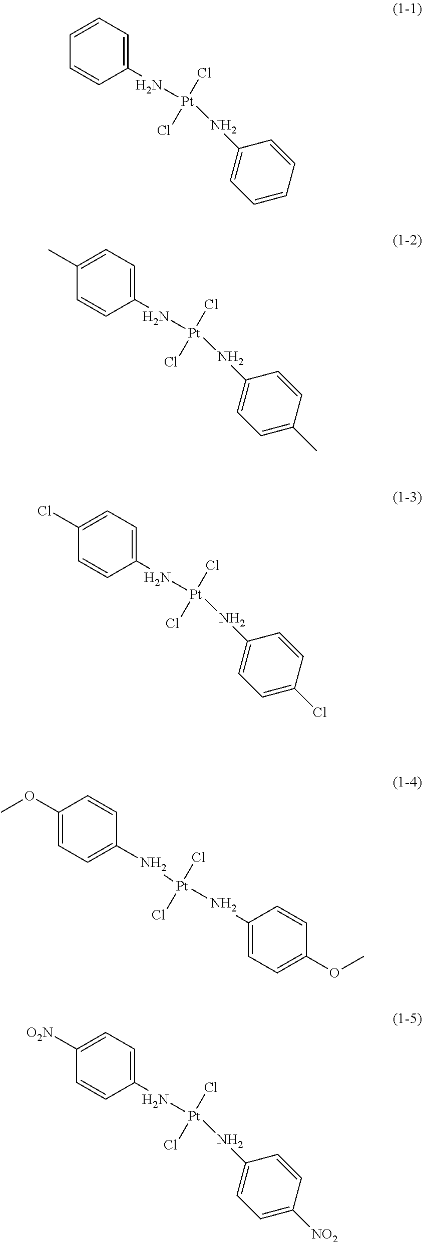

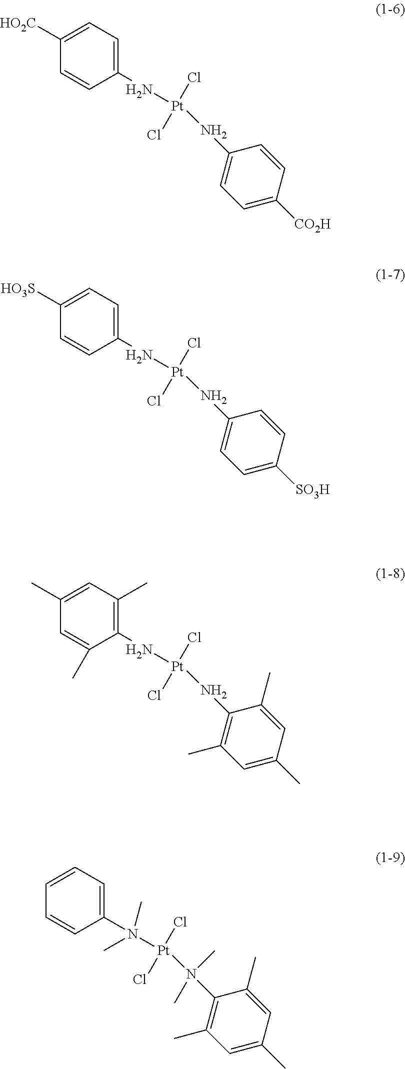

According to another embodiment, the catalyst has the structure of Formula 2-1:

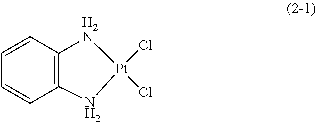

According to another embodiment, the catalyst has one of the following structures:

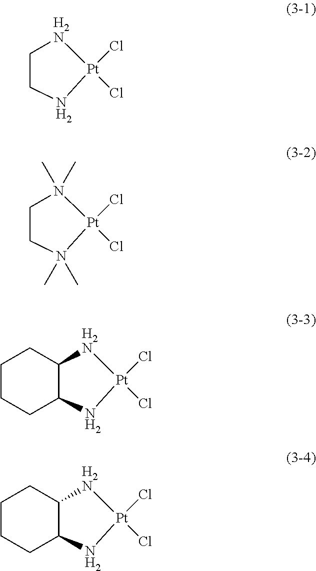

A further aspect of the present invention is directed to a method for methane oxidation including bringing the catalyst for synthesizing methanol or its precursor according to any one of the embodiments into contact with methane in the presence of an acid.

Another aspect of the present invention is directed to a method for methanol production including (a) bringing the catalyst for synthesizing methanol or its precursor according to any one of the embodiments into contact with methane in the presence of an acid to obtain a methanol precursor and (b) bringing the methanol precursor into contact with water to obtain methanol.

Due to its structure, the catalyst of the present invention is highly stable so as not to be easily lost, destroyed, and decomposed in a strongly acidic atmosphere or by oxidation and exhibits good catalytic activity to induce oxidation of the C—H bond of methane. The high stability and good catalytic activity enable the use of the Pt coordination compound represented by Formula 1 as a catalyst in various reactions, such as the oxidation reactions. Specifically, the Pt coordination compound can be used as a catalyst for methane oxidation or a catalyst for the synthesis of methanol from methane.

Particularly, it was confirmed that the catalyst having the structure of Formula 3 does not need to be regenerated for reuse and is stable enough to maintain its activity even after repeated use.

Another aspect of the present invention is directed to a method for preparing the catalyst including reacting a substituted or unsubstituted aniline with a Pt salt, as depicted in the following reaction scheme:

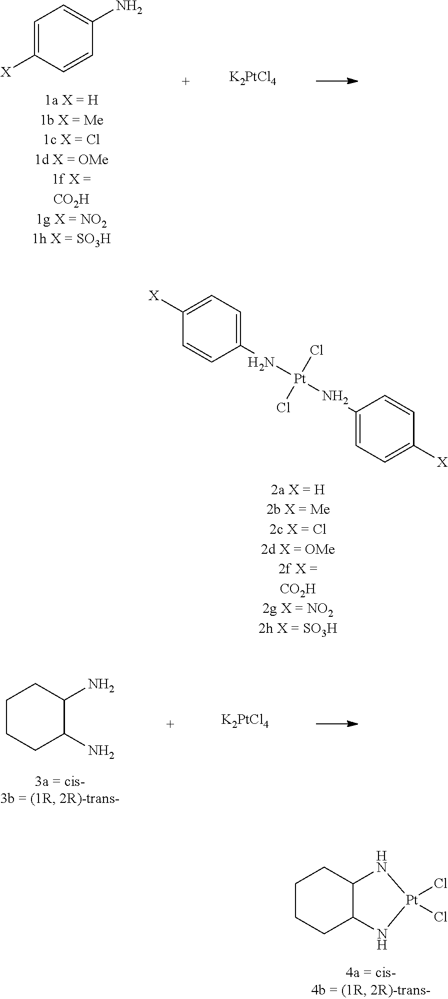

Another aspect of the present invention is directed to a method for methane oxidation including (a) bringing the catalyst for synthesizing methanol or its precursor according to any one of the embodiments into contact with methane in the presence of an acid.

As explained earlier, the catalyst for synthesizing methanol or its precursor according to the present invention, which is represented by one of Formulae 1 to 3, can be used to form a methyl ester through an esterification reaction for methane oxidation. The methyl ester can be used to form a functional derivative by subsequent reaction with a nucleophile.

Specifically, the methyl ether may react with water as a nucleophile to synthesize methanol as a functional derivative. The methyl ester may also react with a hydrogen halide, such as HCl, HBr or HI, as a nucleophile to synthesize a methyl halide as a functional derivative. The methyl ester may also react with NH₃ as a nucleophile to synthesize methylamine. The methyl ester may also react with HCN, H₂S or acetonitrile as a nucleophile to synthesize their methyl derivatives.

The catalyst represented by one of Formulae 1 to 3 for synthesizing methanol or its precursor according to the present invention can be used to oxidize methane to a methyl ester (e.g., methyl bisulfate), which reacts with water to form methanol. This series of reactions will be described in more detail below.

Any compound having an unshared pair of electrons may be used without particular limitation as the nucleophile. Examples of preferred nucleophiles include water, inorganic acids, organic acids, amines, and phenols.

The acids may be acid solutions commonly used in the art but are not particularly limited thereto. Preferably, the acids are sulfuric acid and fuming sulfuric acid.

Fuming sulfuric acid refers to a solution of sulfur trioxide (SO₃) in sulfuric acid. The content of SO₃ may vary in a broad range but is typically from 1 to 60% by weight, more preferably 20% by weight. For example, fuming sulfuric acid containing 20% by weight of SO₃ means the presence of 20 g of SO₃ in 100 g of fuming sulfuric acid.

The production of the alkyl ester may vary depending on the mixing weight ratio between the catalyst represented by one of Formulae 1 to 3 for synthesizing methanol or its precursor and the acid. Accordingly, the mixing weight ratio between the catalyst for synthesizing methanol or its precursor and the acid is considered a very important factor in determining the yield of the alkyl ester.

Preferably, the content of the catalyst represented by one of Formulae 1 to 3 for synthesizing methanol or its precursor is from 0.00001 to 1 mmol or the mixing weight ratio between the catalyst for synthesizing methanol or its precursor and the acid is from 0.000001:1 to 0.1:1. When the catalyst for synthesizing methanol or its precursor meets the preferred requirement, it has a TON of at least 1,000 and a TOF (/h) of at least 300, which are at least 10 times higher than those of existing platinum coordination compounds.

Step (a) is preferably carried out at 150 to 300° C. Out of this temperature range, the catalyst is less catalytically active for the oxidation of at least one C—H bond of the C₁-C₈ alkane, and as a result, the corresponding alkyl ester is produced in an amount less than about half (≤1 g) the amount produced when step (a) is carried out at 150 to 300° C. and the TON and TOF (/h) of the catalyst are significantly reduced to ≤1000 and ≤700, respectively. Meanwhile, if step (a) is carried out at a temperature exceeding 300° C., there is a risk that the reaction may proceed too rapidly and the catalyst can decompose.

In step (a), the C₁-C₈ alkane is preferably supplied at a pressure of 10 to 50 bar. If the pressure of the C₁-C₈ alkane supplied to a reactor is less than 10 bar, the catalyst is less catalytically active for the oxidation of at least one C—H bond of the C₁-C₈ alkane, and as a result, the corresponding alkyl ester is produced in an amount less than about half (≤1 g) the amount produced when the C₁-C₈ alkane is supplied at a pressure of 10 to 50 bar and the TON and TOF (/h) of the catalyst are significantly reduced although the temperature is within the preferred range defined above. Particularly, if the pressure of the C₁-C₈ alkane supplied to a reactor is less than 10 bar, the TOF (/h) of the catalyst is reduced to 348, which corresponds to less than about half that when the C₁-C₈ alkane is supplied at a pressure of 10 to 50 bar.

The most preferred reaction conditions for the production of methanol using the catalyst for synthesizing methanol or its precursor according to the present invention are a temperature of 200 to 250° C. and a pressure of 25 to 35 bar. The use of the catalyst according to the present invention under the reaction conditions defined above ensures high-yield production of methyl bisulfate with a turnover number (TON) of 3,000 to 15,000 and a turnover frequency (TOF) of 1,000 to 6,000.

Yet another aspect of the present invention is directed to a method for methanol production including (a) bringing the catalyst for synthesizing methanol or its precursor according to any one of the embodiments into contact with methane in the presence of an acid to obtain a methanol precursor and (b) bringing the methanol precursor into contact with water to obtain methanol.

According to the method of the present invention, methanol is specifically synthesized by the following reaction scheme 1:

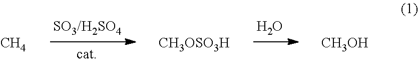

wherein ‘cat.’ represents the catalyst represented by one of Formulae 1 to 3 for synthesizing methanol or its precursor.

Step (b) may be carried out in the range of room temperature to 150° C. Outside this range, further energy is consumed without a significant increase in yield.

The catalyst of the present invention can be used to synthesize a methanol precursor or methanol from methane gas with high efficiency at low temperature and exhibits better results in terms of TON and TOF values than conventional catalysts. The catalyst of the present invention is highly stable so as not to be damaged, destroyed, and decomposed during the reaction, ensuring its long-term use without loss of platinum. In addition, the catalyst of the present invention exhibits good catalytic activity even without using noble metal platinum. Due to these advantages, the use of a small amount of the catalyst leads to the production of a large amount of methanol.

The catalyst represented by one of Formulae 1 to 3 for synthesizing methanol or its precursor according to the present invention, particularly, the catalyst represented by one of Formulae 4 to 7 for synthesizing methanol or its precursor, is advantageous in terms of methyl bisulfate production, catalytic activities, such as TON and TOF values, and economic efficiency over the prior art catalyst (bpym)PtCl₂, which is known to induce the synthesis of methanol at a reaction temperature of 180 to 220° C. similar to that defined in the present invention.

In addition, the catalyst for synthesizing methanol or its precursor according to the present invention is prepared in an easy and simple manner through a greatly reduced number of processing steps. Therefore, the catalyst of the present invention is advantageous over conventional coordination compounds from an economic and industrial point of view.

The present invention will be explained in more detail with reference to the following examples. However, these examples are not to be construed as limiting or restricting the scope and disclosure of the invention. It is to be understood that based on the teachings of the present invention including the following examples, those skilled in the art can readily practice other embodiments of the present invention whose experimental results are not explicitly presented. It will also be understood that such modifications and variations are intended to come within the scope of the appended claims.

### EXAMPLES

The experimental results of the following examples, including comparative examples, are merely representative and the effects of the exemplary embodiments of the present invention that are not explicitly presented hereinafter can be specifically found in the corresponding sections.

### Example 1: Synthesis of Catalyst Compounds

### (1) Synthesis of Compound 1-1

### Bis(benzenamine)dichloroplatinum

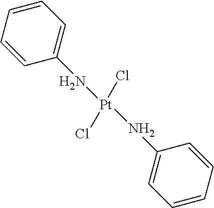

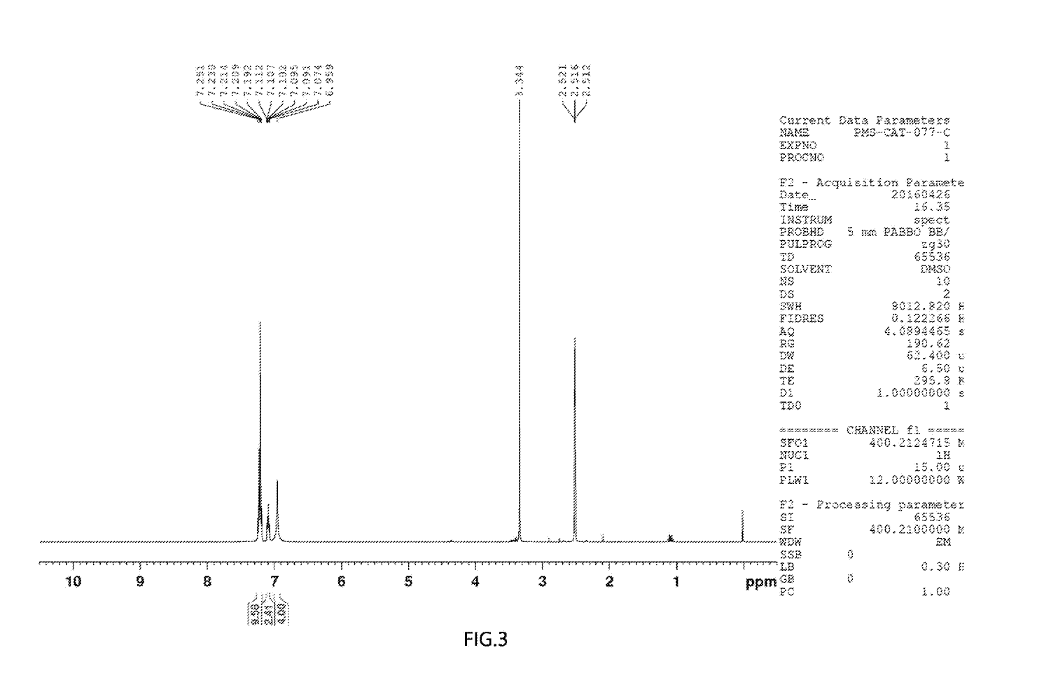

K₂PtCl₄ (415 mg, 1.0 mmol) was added to an aqueous solution of aniline (502 mg, 5.4 mmol). After sufficient stirring at room temperature for 18 h, the precipitate was collected by filtration and washed with water and diethyl ether. The resulting solid was dissolved in dimethylformamide (DMF). The solution was stirred at 80° C. for 3 h. The reaction solution was concentrated under reduced pressure and precipitated with diethyl ether. The precipitate was collected by filtration to give the desired product (105 mg, 4.0 mmol) in a yield of 23%. ¹H NMR (400 MHz, DMSO-d₆) δ 7.24-7.20 (m, 8H), 7.12-7.08 (m, 2H), 6.96 (s, 4H) (see FIG. 3)

### (2) Synthesis of Compound 1-2

### Dichlorobis(4-methylbenzenamine)platinum

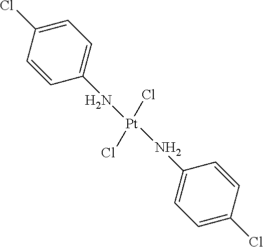

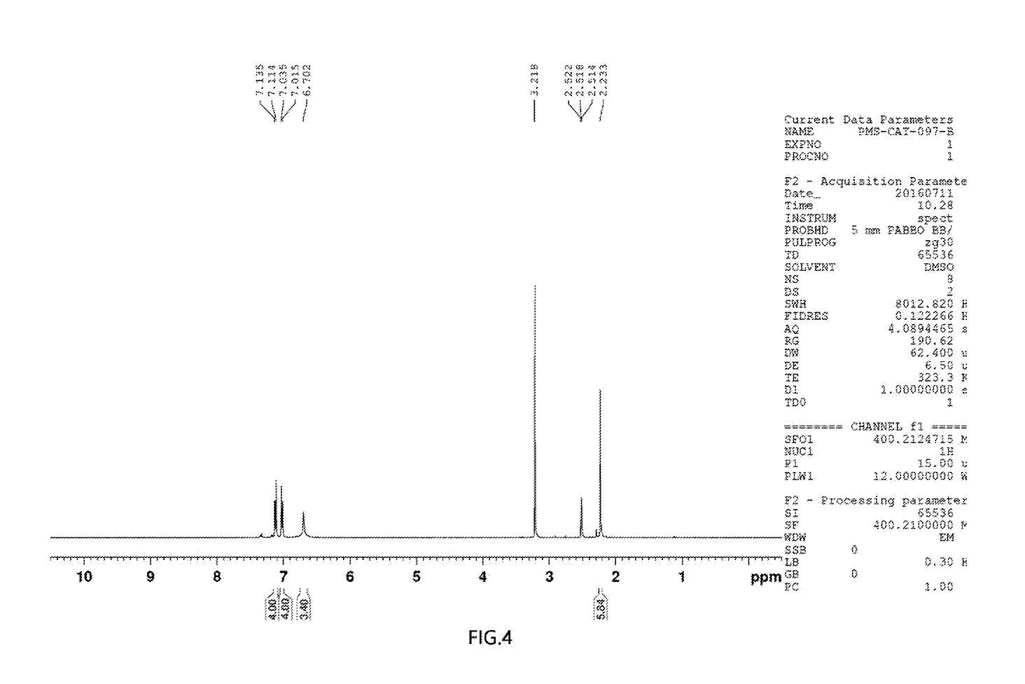

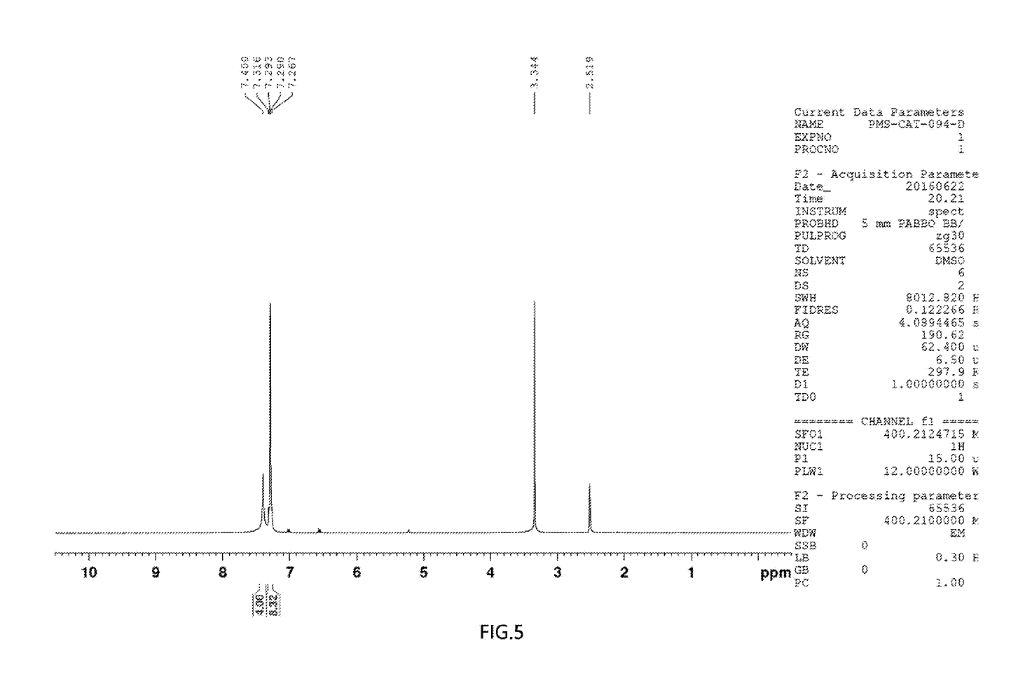

The desired product was obtained in a yield of 37% in the same manner as in the synthesis of Compound 1-1, except that 4-methylaniline was used instead of aniline. ¹H NMR (400 MHz, DMSO-d₆) δ 7.12 (d, J=8.4 Hz, 2H), 8.03 (d, J=8.0 Hz, 2H), 6.70 (s, 4H), 2.22 (s, 6H) (see FIG. 4)

### (3) Synthesis of Compound 1-3

### Dichlorobis(4-chlorobenzenamine)platinum

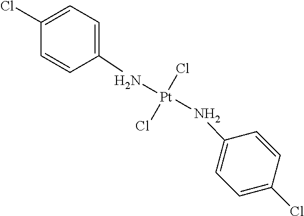

The desired product was obtained in a yield of 63% in the same manner as in the synthesis of Compound 1-1, except that 4-chloroaniline was used instead of aniline. ¹H NMR (400 MHz, DMSO-d₆) δ 7.40 (s, 4H), 7.29 (dd, J=10.4, 9.2 Hz, 8H) (see FIG. 5)

### (4) Synthesis of Compound 1-4

### Dichlorobis(4-methoxybenzenamine)platinum

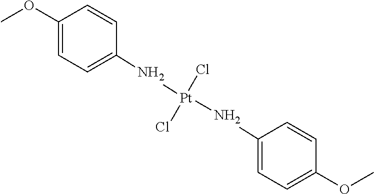

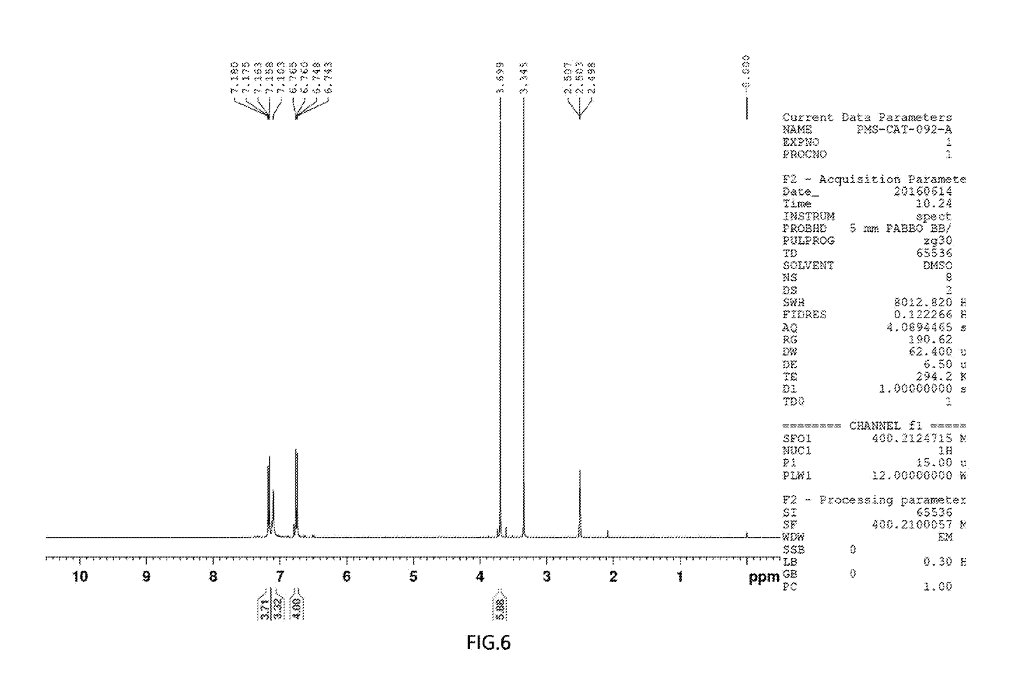

The desired product was obtained in a yield of 43% in the same manner as in the synthesis of Compound 1-1, except that 4-methoxyaniline was used instead of aniline. ¹H NMR (400 MHz, DMSO-d₆) δ 7.17 (dd, J=2.0, 6.8 Hz, 4H), 7.10 (s, 4H), 6.75 (dd, J=2.0, 6.8 Hz, 4H), 3.69 (s, 6H) (see FIG. 6)

### (5) Synthesis of Compound 1-5

### Dichlorobis(4-nitrobenzenamine)platinum

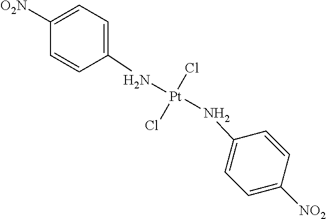

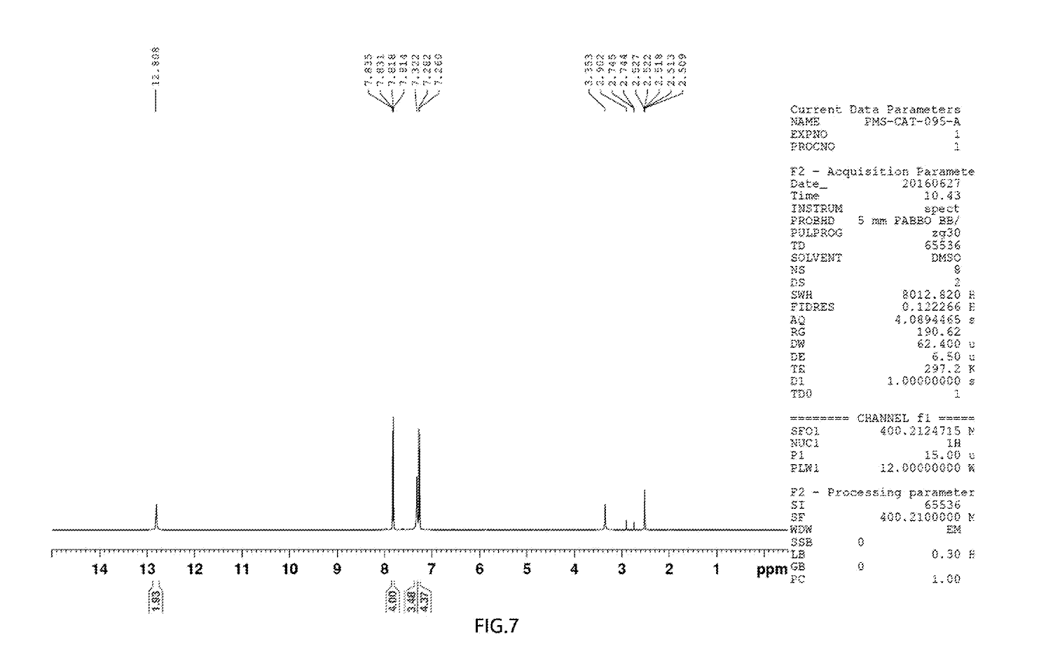

The desired product was obtained in a yield of 43% in the same manner as in the synthesis of Compound 1-1, except that 4-nitroaniline was used instead of aniline. ¹H NMR (400 MHz, DMSO-d₆) δ 12.80 (s, 2H), 7.82 (dd, J=6.8, 1.6 Hz, 4H), 7.32 (s, 4H), 7.27 (d, J=8.8, 4H) (see FIG. 7)

### (6) Synthesis of Compound 1-6

### Dichlorobis(4-hydroxycarbonylbenzenamine)platinum

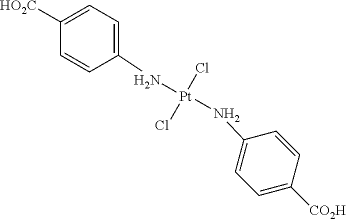

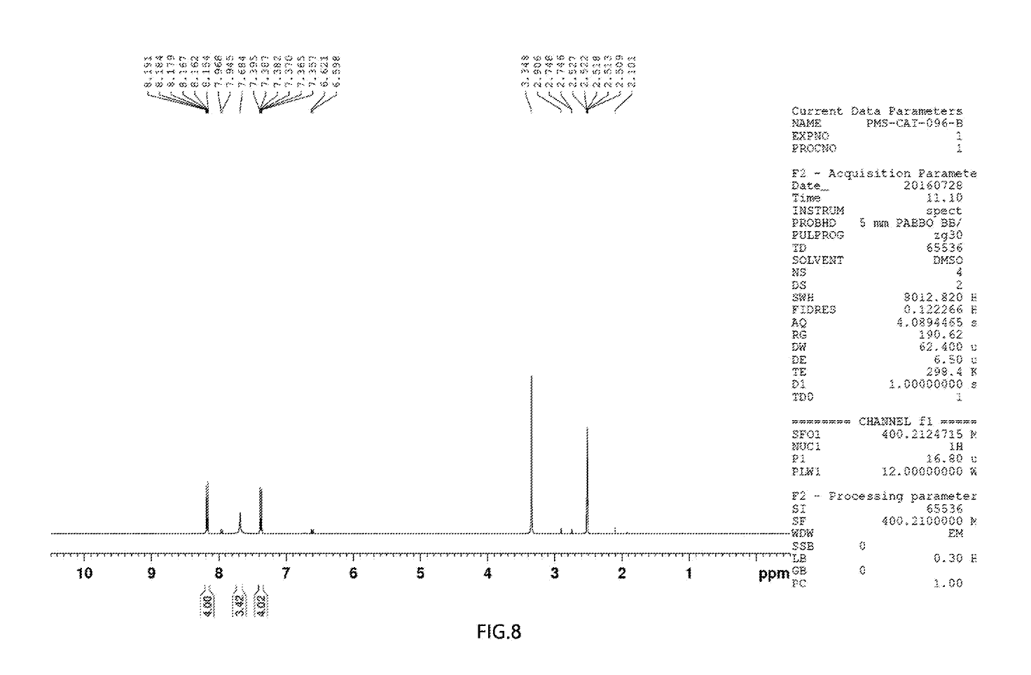

The desired product was obtained in a yield of 43% in the same manner as in the synthesis of Compound 1-1, except that 4-aminobenzoic acid was used instead of aniline. ¹H NMR (400 MHz, DMSO-d₆) δ 12.80 (s, 2H), 7.82 (dd, J=6.8, 1.6 Hz, 4H), 7.32 (s, 4H), 7.27 (d, J=8.8, 4H) (see FIG. 8)

### (7) Synthesis of Compound 1-7

### Dichlorobis(4-hydroxysulfonylbenzenamine)platinum

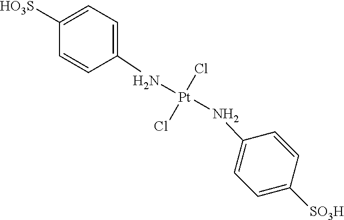

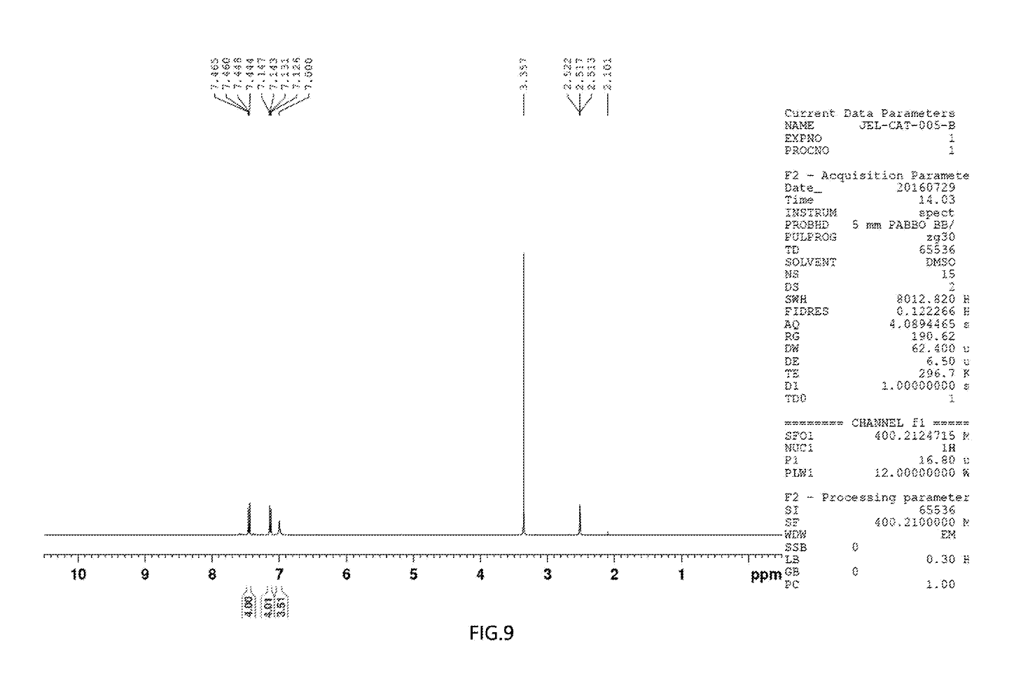

The desired product was obtained in a yield of 59% in the same manner as in the synthesis of Compound 1-1, except that 4-aminobenzenesulfonic acid was used instead of aniline. ¹H NMR (400 MHz, DMSO-d₆) δ 7.45 (dd, J=2.8, 6.6 Hz, 4H), 7.00 (s, 4H) (see FIG. 9)

### (8) Synthesis of Compound 1-8

### Dichlorobis(2,4,6-trimethylbenzenamine)platinum

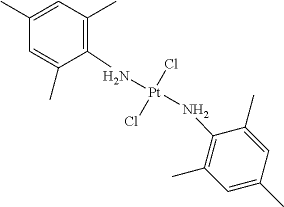

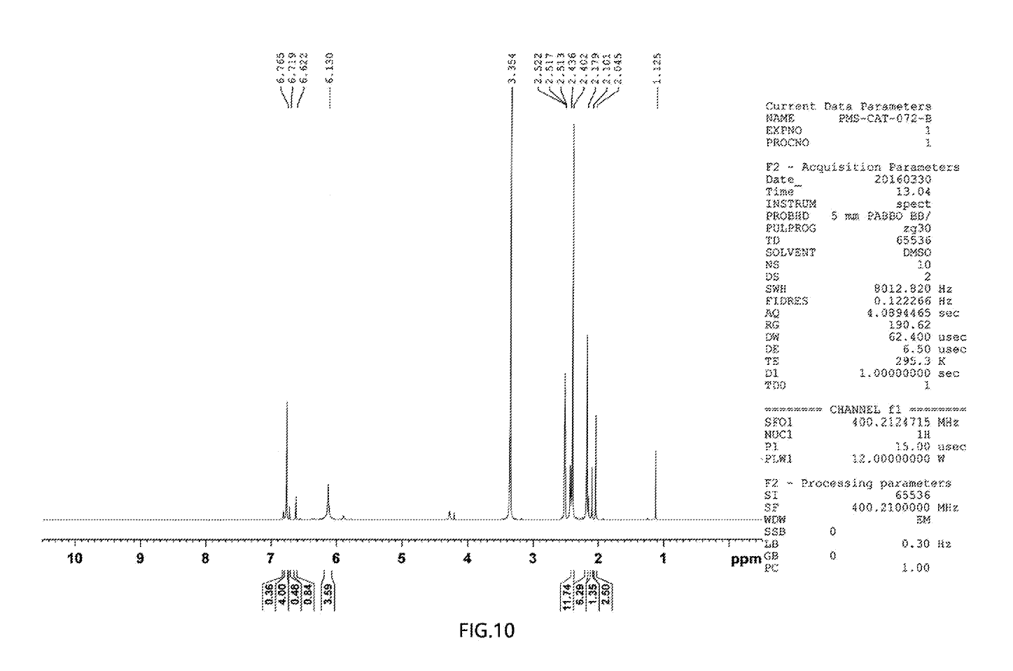

The desired product was obtained in a yield of 30% in the same manner as in the synthesis of Compound 1-1, except that 2,4,6-trimethylaniline was used instead of aniline. ¹H NMR (400 MHz, DMSO-d₆) δ 6.72 (s, 4H), 6.13 (s, 4H), 2.44 (s, 12H), 2.18 (s, 6H) (see FIG. 10)

### (9) Synthesis of Compound 2-1

### Dichloro-(1,2-benzenediamine)platinum

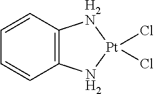

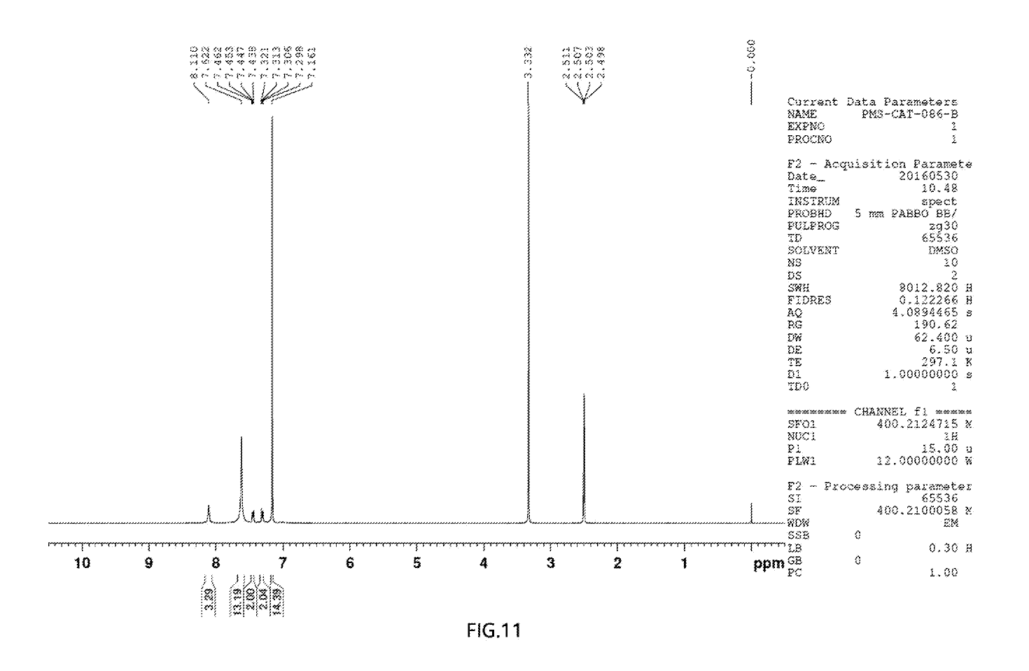

The desired product was obtained in a yield of 73% in the same manner as in the synthesis of Compound 3-3, except that 1,2-diaminobenzene (1 eq.) was added to an aqueous solution of K₂PtCl₄ (1 eq.). ¹H NMR (400 MHz, DMSO-d₆) δ 7.62 (s, 4H), 7.16 (s, 4H) (see FIG. 11)

### (10) Synthesis of Compound 3-1

### Dichloro(ethylenediamine)platinum

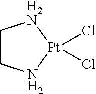

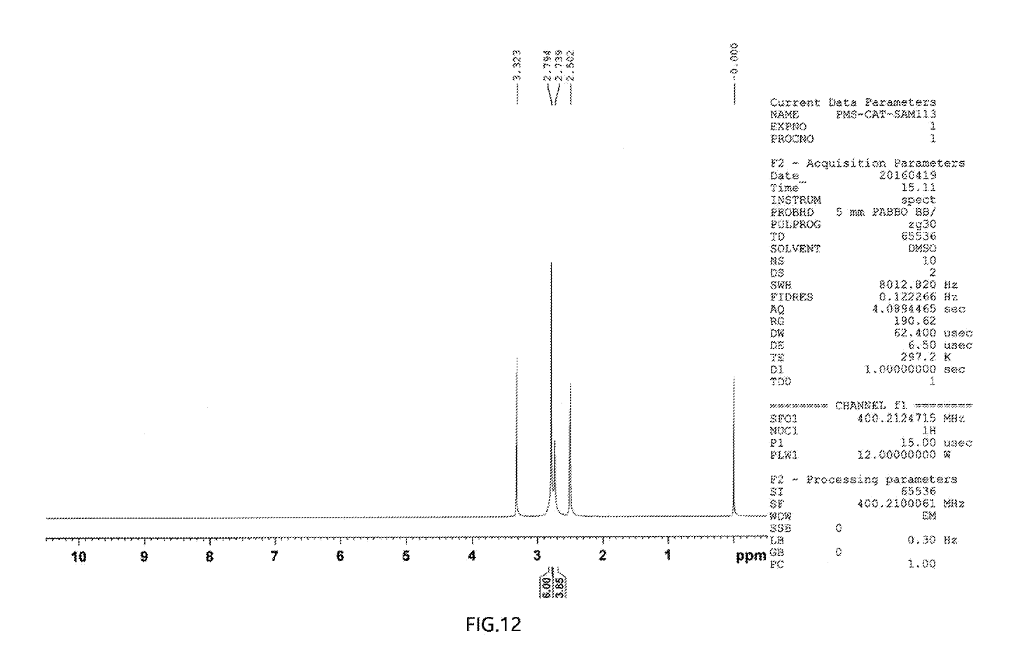

The desired product was obtained in a yield of 60% in the same manner as in the synthesis of Compound 3-3, except that ethylene diamine (1 eq.) was added to an aqueous solution of K₂PtCl₄ (1 eq.). ¹H NMR (400 MHz, MeOD) δ 2.79 (s, 6H), 2.74 (s, 4H) (see FIG. 12)

### (11) Synthesis of Compound 3-2

### Dichloro-(N,N,N,N-tetramethylethylenediamine)platinum

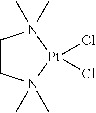

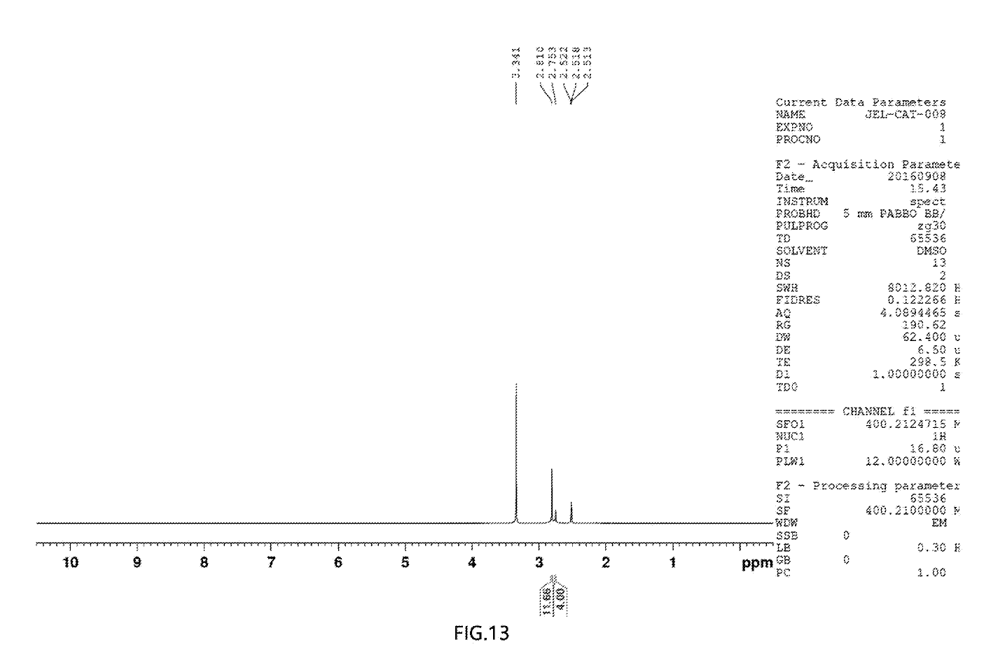

The desired product was obtained in a yield of 87% in the same manner as in the synthesis of Compound 3-3, except that N,N,N′N′-tetramethylethylenediamine (1 eq.) was added to an aqueous solution of K₂PtCl₄ (1 eq.). ¹H NMR (400 MHz, D₂SO₄) δ 2.81 (s, 12H), 2.75 (s, 4H) (see FIG. 13)

### (12) Synthesis of Compound 3-3

### Dichloro-cis-1,2-cyclohexanediamine platinum

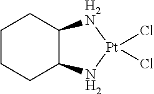

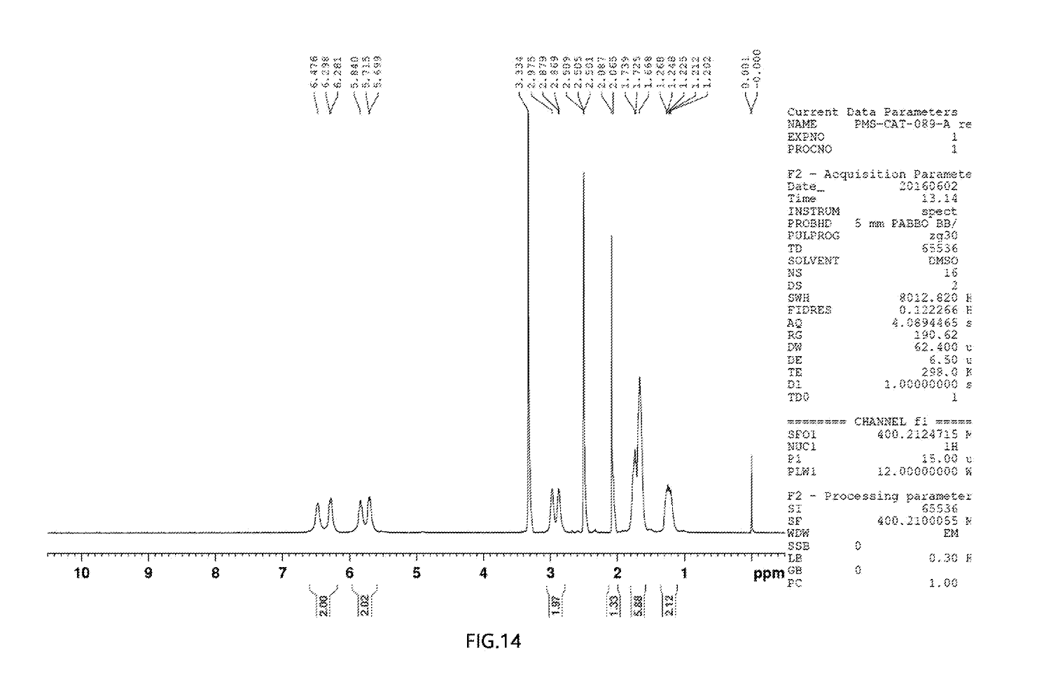

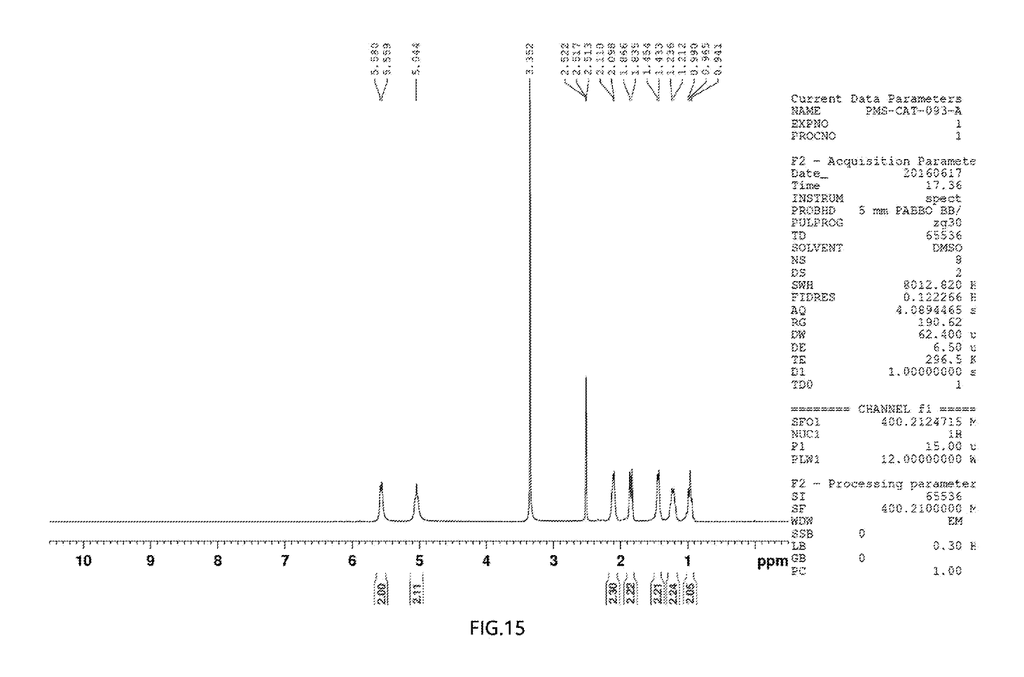

Cis-1,2-cyclohexanediamine (1 eq.) was added to an aqueous solution of K₂PtCl₄ (1 eq.). The mixture was stirred at room temperature for 30 min. The resulting precipitate was collected by filtration and washed with water and diethyl ether, giving the desired product in a yield of 83%. ¹H NMR (400 MHz, DMSO-d₆) δ 5.52 (d, J=6.8 Hz, 2H), 4.94 (t, J=4.6 Hz, 2H), 2.59 (m, 2H) 1.64 (m, 6H) 1.14 (d, J=4.8 Hz, 2H) (see FIG. 14)

### (13) Synthesis of Compound 3-4

### Dichloro-(1R,2R)-1,2-cyclohexanediamine platinum

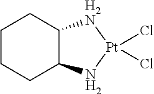

The desired product was obtained in a yield of 85% in the same manner as in the synthesis of Compound 3-3, except that trans-1,2-cyclohexanediamine (1 eq.) was added to an aqueous solution of K₂PtCl₄ (1 eq.). ¹H NMR (400 MHz, DMSO-d₆) δ 5.57 (d, J=8.4 Hz, 2H), 5.04 (s, 2H), 2.10 (d, J=4.8 Hz, 2H), 1.85 (d, J=12.4 Hz, 2H) 1.44 (d, J=8.4 Hz, 2H) 1.22 (d, J=9.6 Hz, 2H) 0.97 (t, J=9.6, 2H) (see FIG. 15)

### Example 2: Synthesis of Methanol Precursor and Methanol

(1) Synthesis of Methyl Bisulfate

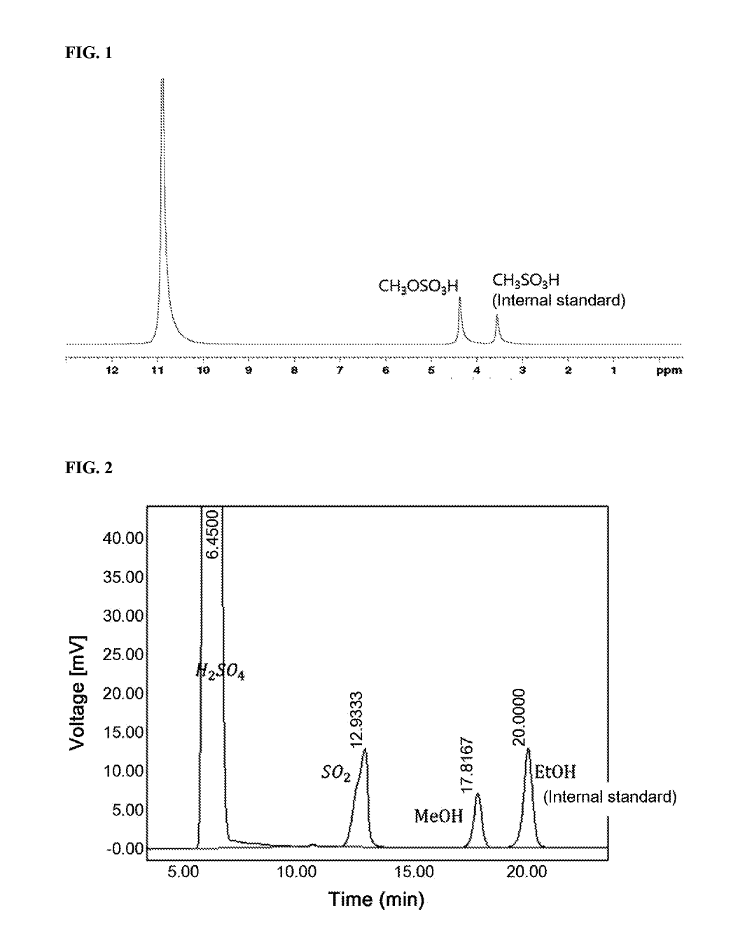

1 mg (2.6×10⁻³ mmol) of the catalyst (dichloro-(N,N,N,N-tetramethylethylenediamine)platinum) represented by Formula 3-2 was mixed with 30 g of fuming sulfuric acid containing 20 wt % of SO₃ in a 100 ml Inconel autoclave with a glass liner. Methane gas was filled in the reactor to a pressure of 20 bar. The methane-filled reactor was heated to 180° C. and the reaction was allowed to proceed for 3 h. The pressure of the methane at 180° C. was 35 bar at the initial stage of the reaction and decreased to 30 bar after the reaction for 3 h. After completion of the reaction, the structure of the product was identified by ¹H-NMR spectroscopy using D₂SO₄ containing methanesulfonic acid (CH₃SO₃H) as the internal standard (see FIG. 1).

FIG. 1 confirms the production of 1.89 g (16.9 mmol) of methyl bisulfate. The turnover number (TON) and turnover frequency (TOF) of the catalyst for the production of methyl bisulfate were calculated to be 6,484 and 2,161/h, respectively.

(2) Methanol Synthesis

200 g of distilled water was added to the methyl bisulfate obtained above and ethanol as the internal standard was added thereto. The reaction was allowed to proceed at 90° C. for 4 h. After completion of the reaction, the reaction product was analyzed by HPLC. The results are shown in FIG. 2, confirming the production of 0.51 g of methanol.

(3) Comparison of the Amounts of Methyl Bisulfate Produced when the Catalyst was Used in Different Amounts

An investigation was made as to the effect of the consumption of the catalyst represented by Formula 3-2 on the synthesis of methyl bisulfate as a methanol precursor. To this end, methyl bisulfate as a methanol precursor was produced in the same manner as in Example 2, except that the catalyst was used in the amounts shown in Table 1. After completion of the reaction, the methyl bisulfate was quantitatively analyzed by ¹H-NMR spectroscopy. The results are shown in Table 1.

TABLE 1

| | | | Amount of | | |
|---|---|---|---|---|---|
| | Compound | Amount of | CH₃OSO₃H | | TOF |
| Catalyst structure | No. | catalyst used | produced | TON | (/h) |
| 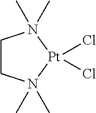 | 3-2 | 10 mg, 2.6 × 10⁻² mmol | 3.28 g, 29.3 mmol | 1,126 | 376 |
| Ditto | Ditto | 5 mg, 1.3 × 10⁻² mmol | 2.88 g, 25.7 mmol | 1,978 | 659 |
| Ditto | Ditto | 2 mg, 5.2 × 10⁻³ mmol | 2.32 g, 20.7 mmol | 3,980 | 1,327 |
| Ditto | Ditto | 0.5 mg, 1.3 × 10⁻³ mmol | 1.38 g, 12.3 mmol | 9,461 | 3,153 |
| Ditto | Ditto | 0.25 mg, 6.5 × 10⁻⁴ mmol | 1.0 g, 8.9 mmol | 13,692 | 4,564 |

As can be seen from the results in Table 1, the TON and TOF of the catalyst of Formula 3-2 for the production of methyl bisulfate increased with decreasing amount of the catalyst. That is, the mixing weight ratio of the catalyst of Formula 3-2 to fuming sulfuric acid has an important influence on the production of methyl bisulfate. It was also confirmed that the production of methyl bisulfate is proportional to the consumption of the catalyst.

These results reveal the effective content range of the catalyst. When the concentration of the catalyst was 0.0001-1 mM, the TON (≥2,000) and TOF (≥700/h) of the catalyst were significantly high. The TON and TOF values are at least 5 times higher than those of the conventional catalyst (bpym)PtCl₂. Specifically, when the catalyst of Formula 3-2 was used in the same amount (0.0005-0.0007 mmol) as the conventional catalyst, the TON and TOF (/h) of the catalyst of Formula 3-2 were improved by at least 40 times compared to those of the conventional catalyst (bpym)PtCl₂.

The mixing weight ratio of the catalyst of Formula 5 to fuming sulfuric acid may be from 0.000001:1 to 0.1:1. More preferably, the mixing weight ratio of the catalyst of Formula 5 to fuming sulfuric acid is in the range of 0.000008:1 to 0.0001:1. Within this range, a large amount of methyl bisulfate (≥1 g (8 mmol)) can be formed in the course of the synthesis of methanol and high TON (≥2000) and TOF (≥700/h) values can be achieved. That is, the catalyst of the present invention enables the production of a sufficiently large amount of methyl bisulfate even when used in a small amount. The above results demonstrate that when the catalyst of the present invention (particularly, the catalyst of Formula 5) is used in an amount of 5×10⁻⁴ to 1×10³ mmol, the largest amount of methyl bisulfate or methanol can be produced from methane supplied. In conclusion, even a very small amount of the catalyst of the present invention is sufficient to convert a large amount of methane to methanol.

In contrast, the Periana catalyst used in the following comparative example 1 was confirmed to show poor catalytic activity compared to the catalyst for synthesizing methanol or its precursor according to the present invention when used in similar amounts.

(4) Comparison of the Amounts of Methyl Bisulfate Produced Depending on the Catalyst Structures

The reactivity of the catalyst depending on its structure was investigated. To this end, methyl bisulfate was produced in the same manner as described above, except that the structure of the catalyst was changed as shown in Table 2. After completion of each reaction, the product was analyzed by ¹H-NMR spectroscopy. The results are shown in Table 2. The amount of each catalyst used was 1 mg.

TABLE 2

| | | Amount of | Amount of | | |
|---|---|---|---|---|---|
| | Compound | catalyst used | CH₃OSO₃H | | TOF |
| Catalyst structure | No | (mmol) | produced | TON | (/h) |
| 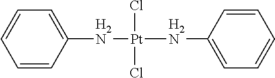 | 1-1 | 2.21 × 10⁻³ | 1.46 g 13.05 mmol | 6526 | 2175 |
| 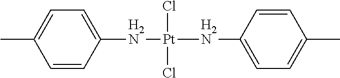 | 1-2 | 2.08 × 10⁻³ | 1.28 g 11.46 mmol | 5714 | 1904 |
| 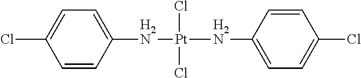 | 1-3 | 1.92 × 10⁻³ | 1.40 g 12.46 mmol | 6578 | 2192 |
| 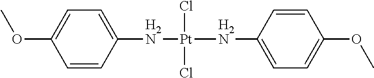 | 1-4 | 1.95 × 10⁻³ | 1.33 g 11.91 mmol | 6250 | 2083 |
| 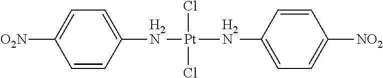 | 1-5 | 1.85 × 10⁻³ | 1.34 g 11.92 mmol | 6440 | 2146 |
| 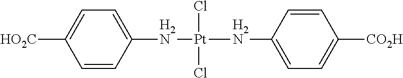 | 1-6 | 1.86 × 10⁻³ | 1.35 g 12.09 mmol | 6501 | 2167 |
| 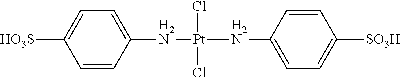 | 1-7 | 1.64 × 10⁻³ | 1.15 g 10.27 mmol | 6272 | 2090 |
| 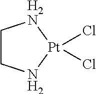 | 3-1 | 3.07 × 10⁻³ | 2.13 g 19.04 mmol | 6210 | 2070 |
| 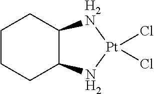 | 3-3 | 2.60 × 10⁻³ | 0.45 g 4.02 mmol | 1546 | 515 |
| 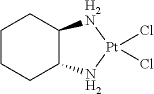 | 3-4 | 2.60 × 10⁻³ | 0.49 g 4.37 mmol | 1680 | 560 |

(5) Comparison of the Amounts of Methyl Bisulfate Produced Depending on Reaction Conditions

An investigation was made as to the effect of reaction conditions for methanol synthesis on the synthesis of methyl bisulfate as a methanol precursor. To this end, methyl bisulfate as a methanol precursor was produced in the same manner as described above, except that the reaction conditions for methanol synthesis were changed as shown in Table 3. After completion of the reaction, the product was analyzed by ¹H-NMR spectroscopy. The results are shown in Table 3. The amount of the catalyst used was 1 mg (0.0026 mmol).

TABLE 3

| | | Conditions for | | | | |
|---|---|---|---|---|---|---|
| | | CH₃OSO₃H synthesis | | Amount of | | |
| | Compound | Temperature | Methane | CH₃OSO₃H | | TOF |
| Catalyst structure | No. | (° C.) | pressure (bar) | produced | TON | (/h) |
| 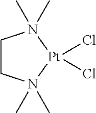 | 3-2 | 120 | 35 | 0.088 g, 0.786 mmol | 303 | 101 |
| Ditto | Ditto | 150 | 35 | 0.33 g, 2.95 mmol | 1,135 | 378 |
| Ditto | Ditto | 180 | 25 | 1.29 g, 11.5 mmol | 4,423 | 1,474 |
| Ditto | Ditto | 180 | 10 | 0.70 g, 6.25 mmol | 2,403 | 801 |
| Ditto | Ditto | 220 | 35 | 3.16 g, 28.3 mmol | 10,884 | 3,628 |

As shown in Table 3, when the reaction temperature for methanol synthesis was lower than 150° C., the amount of methyl bisulfate produced was considerably reduced to less than about half (≤0.5 g) the amount produced when the reaction temperature was not lower than 150° C. and the TON and TOF (/h) values were considerably reduced to 200 and 90, respectively. When the pressure of methane in the reactor was lower than 10 bar and the other reaction conditions, including temperature, were the same, the amount of methyl bisulfate produced was considerably reduced to less than about half (≤1 g) the amount produced when the pressure of methane was not lower than 10 bar and the TON and TOF (/h) values were considerably reduced to 1,000 and 300, respectively. From the above results, it can be seen that preferred reaction conditions for the production of methanol using the Pt coordination compound are a temperature of 150 to 300° C. and a pressure of 10 to 50 bar. If the reaction temperature is lower than 150° C. or higher than 300° C., the amount of methyl bisulfate produced was considerably reduced to less than about half (≤1 g) the amount produced when the reaction temperature was 150-300° C. and the TON and TOF (/h) values were considerably reduced to ≤1,000 and ≤700, respectively.

When the pressure of methane in the reactor was higher than 50 bar or lower than 10 bar and the other reaction conditions, including temperature, were the same, the amount of methyl bisulfate produced was considerably reduced to less than about half (≤1 g) the amount produced when the pressure of methane was 10-50 bar and the TON and TOF (/h) values were also reduced considerably. Particularly, the TOF (/h) was reduced to less than about half (348).

These results can lead to the conclusion that the most preferred reaction conditions for the production of methanol using the catalyst of the present invention are a temperature of 200 to 250° C. and a pressure of 25 to 35 bar. When the catalyst of the present invention is used under the conditions defined above, methyl bisulfate can be obtained in high yield with a turnover number (TON) of 3,000-15,000 and a turnover frequency (TOF) of 1,000-6,000.

### Comparative Example 1

The activity of the Periana catalyst ((bpym)PtCl₂) as a conventional platinum catalyst for methanol synthesis was compared with that of the platinum catalyst of the present invention. To this end, methanol was produced in the same manner as in Example 2, except that the amount of the Periana catalyst ((bpym)PtCl₂) was adjusted as shown in Table 4. The Periana catalyst was prepared in accordance with the method described in “Solid Catalysts for the Selective Low-Temperature Oxidation of Methane to Methanol, Author: Regina Palkovits Dr., Markus Antonietti Prof. Dr., Pierre Kuhn Dr., Arne Thomas Dr., Ferdi Schrüth Prof. Dr., Volume 48, Issue 37 Sep. 1, 2009 Pages 6909-6912. After completion of the reaction, the methyl bisulfate was analyzed by ¹H-NMR spectroscopy. The results are shown in Table 4.

TABLE 4

| | Conditions for methanol | | | | |
|---|---|---|---|---|---|
| | synthesis | | Amount of | | |
| | Temper- | Methane | methane | | |
| Amount of | ature | pressure | sulfate | | TOF |
| catalyst used | (° C.) | (bar) | produced | TON | (/h) |
| 20 mg, 4.7 × | 150 | 35 | 0.58 g, | 110 | 36 |
| 10⁻² mmol | | | 5.17 mmol | | |
| 5 mg, 1.1 × | 180 | 35 | 0.49 g, | 366 | 122 |
| 10⁻² mmol | | | 4.3 mmol | | |
| 1 mg, 2.35 × | 180 | 35 | — | | |
| 10⁻³ mmol | | | | | |

As can be seen from the results in Table 4, the production of methyl bisulfate was not affected by the content of the conventional catalyst (bpym)PtCl₂ and the conditions for methanol synthesis. In addition, when the conventional catalyst was used, a significantly small amount (0.5 g, 0.3 mmol) of methyl bisulfate was produced and low TON (110 and 432) and TOF (36 and 144/h) were obtained. The TON and TOF values were at least 10-fold lower than those obtained when the catalyst of the present invention was used.

What is claimed is:

1. A catalyst for synthesizing methanol or its precursor, represented by one of Formulae 1, 2, and 3: 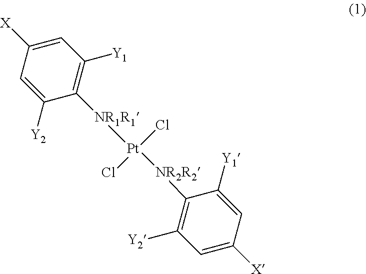
wherein R₁, R₁′, R₂, and R₂′ are the same as or different from each other and are each independently hydrogen or a C₁-C₃ alkyl group, X and X′ are the same as or different from each other and are each independently selected from hydrogen, C₁-C₃ alkyl groups, halogen groups, C₁-C₃ alkoxy groups, a nitro group, a carboxyl group, and a sulfonic acid group (—SO₃H), and Y₁, Y₁′, Y₂, and Y₂′ are the same as or different from each other and are each independently hydrogen or a C₁-C₃ alkyl group; 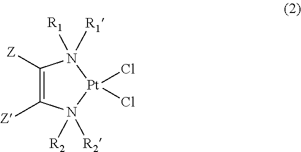
wherein R₁, R₁′, R₂, and R₂′ are as defined in Formula 1 and Z and Z′ are all hydrogen or together form a benzene or cyclohexyl ring with adjacent carbon atoms; and 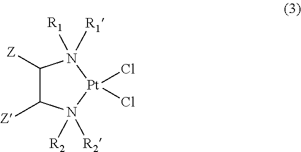
wherein R₁, R₁′, R₂, and R₂′ are as defined in Formula 1 and Z and Z′ are as defined in Formula 2.

2. The catalyst according to claim 1, wherein the catalyst has the structure of Formula 1 wherein R₁, R₁′, R₂, and R₂′ are the same as or different from each other and are each independently hydrogen or a C₁-C₃ alkyl group, X and X′ are the same as or different from each other and are each independently selected from hydrogen, C₁-C₃ alkyl groups, halogen groups, C₁-C₃ alkoxy groups, a nitro group, a carboxyl group, and a sulfonic acid group (—SO₃H), and Y₁, Y₁′, Y₂, and Y₂′ are the same as or different from each other and are each independently hydrogen or a C₁-C₃ alkyl group.

3. The catalyst according to claim 2, wherein R₁, R₁′, R₂, and R₂′ are the same as or different from each other and are each independently hydrogen or a methyl group, X and X′ are the same as or different from each other and are each independently selected from hydrogen, a methyl group, halogen groups, a methoxy group, a nitro group, a carboxyl group, and a sulfonic acid group (—SO₃H), and Y₁, Y₁′, Y₂, and Y₂′ are the same as or different from each other and are each independently hydrogen or a methyl group.

4. The catalyst according to claim 2, wherein R₁, R₁′, R₂, and R₂′ are all hydrogen, X and X′ are the same and are selected from hydrogen, C₁-C₃ alkyl groups, halogen groups, C₁-C₃ alkoxy groups, a nitro group, a carboxyl group, and a sulfonic acid group (—SO₃H), and Y₁, Y₁′, Y₂, and Y₂′ are the same and are hydrogen or a C₁-C₃ alkyl group.

5. The catalyst according to claim 2, wherein R₁, R₁′, R₂, and R₂′ are all hydrogen, X and X′ are the same and are selected from hydrogen, a methyl group, halogen groups, a methoxy group, a nitro group, a carboxyl group, and a sulfonic acid group (—SO₃H), and Y₁, Y₁′, Y₂, and Y₂′ are the same and are hydrogen or a methyl group.

6. The catalyst according to claim 1, wherein the catalyst has the structure of Formula 2 wherein R₁, R₁′, R₂, and R₂′ are the same as or different from each other and are each independently hydrogen or a C₁-C₃ alkyl group and Z and Z′ are all hydrogen or together form a benzene ring with adjacent carbon atoms.

7. The catalyst according to claim 6, wherein R₁, R₁′, R₂, and R₂′ are the same as or different from each other and are each independently hydrogen or a methyl group and Z and Z′ are all hydrogen or together form a benzene ring with adjacent carbon atoms.

8. The catalyst according to claim 6, wherein R₁, R₁′, R₂, and R₂′ are the same and are hydrogen or a C₁-C₃ alkyl group and Z and Z′ are all hydrogen or together form a benzene ring with adjacent carbon atoms.

9. The catalyst according to claim 6, wherein R₁, R₁′, R₂, and R₂′ are the same and are hydrogen or a methyl and Z and Z′ are all hydrogen or together form a benzene ring with adjacent carbon atoms.

10. The catalyst according to claim 1, wherein the catalyst has the structure of Formula 3 wherein R₁, R₁′, R₂, and R₂′ are the same as or different from each other and are each independently hydrogen or a C₁-C₃ alkyl group and Z and Z′ are all hydrogen or together form a cyclohexyl ring with adjacent carbon atoms.

11. The catalyst according to claim 10, wherein R₁, R₁′, R₂, and R₂′ are the same as or different from each other and are each independently hydrogen or a methyl group and Z and Z′ are all hydrogen or together form a cyclohexyl ring with adjacent carbon atoms.

12. The catalyst according to claim 10, wherein R₁, R₁′, R₂, and R₂′ are the same and are hydrogen or a C₁-C₃ alkyl group and Z and Z′ are all hydrogen or together form a cyclohexyl ring with adjacent carbon atoms.

13. The catalyst according to claim 10, wherein R₁, R₁′, R₂, and R₂′ are the same and are hydrogen or a methyl and Z and Z′ are all hydrogen or together form a cyclohexyl ring with adjacent carbon atoms.

14. The catalyst according to claim 1, wherein the catalyst has one of the following structures:

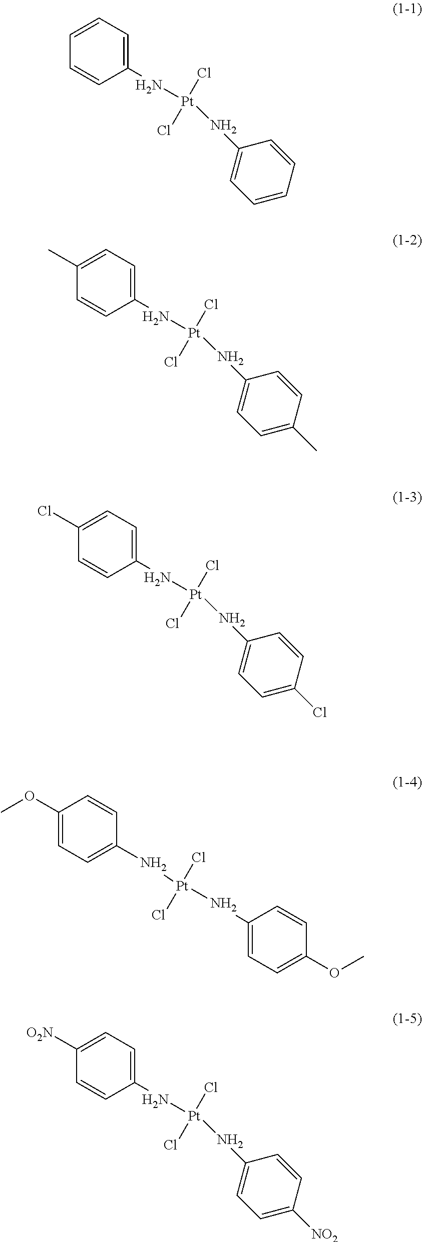

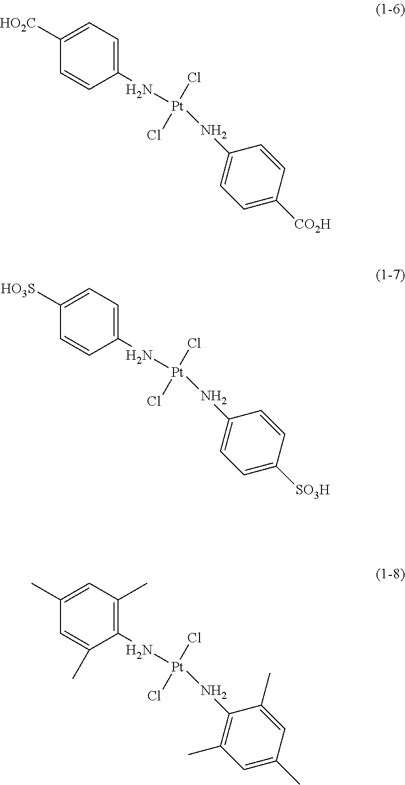

15. The catalyst according to claim 1, wherein the catalyst has the structure of Formula 2-1:

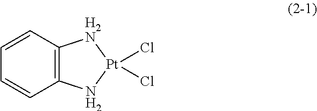

16. The catalyst according to claim 1, wherein the catalyst has one of the following structures: [chemical structure]
